(19) United States
(12) Patent Application Publication
(10) Pub. No.: US 2012/0131179 A1
(43) Pub. Date: May 24, 2012

(54) METHOD AND SYSTEM FOR REMOTE OS INSTALLATION CAPABLE OF MONITORING AN INSTALLATION PROCEDURE

(76) Inventor: Chih-Kai HU, Tucheng City (TW)

(21) Appl. No.: 12/970,309

(22) Filed: Dec. 16, 2010

(30) Foreign Application Priority Data
Nov. 22, 2010 (TW) 99140150

(51) Int. Cl. G06F 15/173; G06F 15/177

(52) U.S. Cl. 709/224; 713/2

(57) ABSTRACT

A method for remote OS installation capable of monitoring an installation procedure, is applied to a host computer installing an OS remotely on at least one client computer, wherein the host computer includes a control platform, and the method includes: enabling the client computer to connect to the control platform of the host computer through a Pre-Boot execution environment (PXE) to obtain an IP address; enabling the control platform to transmit a virtual platform installation file to the client computer and installing a virtual platform on the client computer; enabling the host computer to obtain administration authority of the client computer through the virtual platform and establishing a control connection and a monitoring channel between the control platform and the virtual platform; and enabling the host computer to install the OS on the client computer via the control connection and obtaining displays of the installation procedure of the client computer via the monitoring channel.

### CROSS REFERENCE TO RELATED APPLICATIONS

This Application claims priority of Taiwan Patent Application No. 099140150, filed on Nov. 22, 2010, the entirety of which is incorporated by reference herein.

### BACKGROUND OF THE INVENTION

1. Field of the Invention

The invention relates to remote operating system (OS) installation, and more particularly to a method, a system and a computer program product capable of monitoring an installation procedure during remote OS installation.

2. Description of the Related Art

Generally, a remote OS installation uses different methods to install different platforms of operating systems. In prior art, a host computer uses a pre-defined kickstart to install a Linux system on client computers remotely through a Pre-Boot eXecution Environment (PXE). The host computer can install and set a plurality of computers at the same time but cannot monitor displays of the installation procedure during the installation. Therefore, if there is any problem in a client computer during installation, the host computer is not able to notice the problem and make a response immediately. Meanwhile, a host computer uses a Remote Install Server (RIS) to install a Windows system on client computers remotely. The client computers use network interface cards having PXE functions and obtain installation files through RIS. The installation procedure cannot be monitored by installing the Windows system through the RIS, and during the installation, the host computer cannot monitor real-time conditions of the installation procedure of client computers either. The two ways described which install operating systems remotely are limited to the operating system platforms. A host computer with an operating system can only support a remote installation method corresponding to the operating system of the host computer.

In prior art, if a host computer wants to monitor displays of the installation procedure when installing the OS remotely, the host computer needs related hardware equipment. For example, a KVM switch over IP or BIOS supporting built-in remote-monitoring software such as HP iLO. Therefore, if a host computer wants to monitor displays of the installation procedure when installing a Linux system and Windows system on client computers by known ways as described above, the host computer needs a KVM switch over IP or remote-monitoring software such as HP iLO.

Nevertheless, using a KVM switch over IP requires installation of additional hardware equipment and additional costs. Also, the KVM switch over IP has a fixed number of connecting ports. The number of client computers connecting to the KVM switch over IP cannot be increased; such that, more connecting ports of the KVM switch over IP would increase costs even greater. Note that monitoring displays of the installation procedure by the remote-monitoring software HP iLO is limited to specific computers which have the built-in remote-monitoring software HP iLO. Also, every computer using the remote-monitoring software HP iLO needs to buy a software license, which increases costs.

### BRIEF SUMMARY OF THE INVENTION

In view of the above, the invention provides a method for remote OS installation capable of monitoring an installation procedure, wherein the method supports cross-platform OS installation (Linux and Windows) and doesn't need additional hardware equipment or software to monitor displays of the installation procedure.

An embodiment of the invention provides a method for remote OS installation capable of monitoring an installation procedure, applied to a host computer installing an OS remotely on at least one client computer, wherein the host computer includes a control platform, and the method comprises: enabling the client computer to connect to the control platform of the host computer through a Pre-Boot execution environment (PXE) to obtain an IP address; enabling the control platform to transmit a virtual platform installation file to the client computer and installing a virtual platform on the client computer; enabling the host computer to obtain administration authority of the client computer through the virtual platform and establishing a control connection and a monitoring channel between the control platform and the virtual platform; and enabling the host computer to install an operating system on the client computer via the control connection and obtaining displays of the installation procedure of the client computer via the monitoring channel.

An embodiment of the invention provides a system for remote OS installation capable of monitoring an installation procedure, constructed in a host computer to install an OS remotely on at least one client computer, wherein the host computer includes a control platform, the client computer connects to the control platform of the host computer through a PXE to obtain an IP address, and the system comprises: a first module, enabling the control platform to transmit a virtual platform installation file to the client computer and installing a virtual platform on the client computer; a second module, obtaining administration authority of the client computer through the virtual platform and establishing a control connection and a monitoring channel between the control platform and the virtual platform; and a third module, installing the OS on the client computer via the control connection and obtaining displays of the installation procedure of the client computer via the monitoring channel.

An embodiment of the invention provides a computer program product for remote OS installation capable of monitoring an installation procedure, loaded by an electronic apparatus to execute a method for remote OS installation capable of monitoring an installation procedure, wherein the method is applied to a host computer installing an OS remotely on at least one client computer, the host computer includes a control platform, the client computer connects to the control platform of the host computer through a PXE to obtain an IP address, and the computer program product comprises: a first code, enabling the control platform to transmit a virtual platform installation file to the client computer and installing a virtual platform on the client computer; a second code, obtaining administration authority of the client computer through the virtual platform and establishing a control connection and a monitoring channel between the control platform and the virtual platform; and a third code, installing the OS on the client computer via the control connection and obtaining displays of the installation procedure of the client computer via the monitoring channel.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a block diagram of a host computer and client computers in accordance with an embodiment of the invention;

FIG. 2 illustrates a flow chart of a method for remote OS installation capable of monitoring an installation procedure in accordance with an embodiment of the invention;

FIG. 3 illustrates a block diagram of a system for remote OS installation capable of monitoring an installation procedure in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

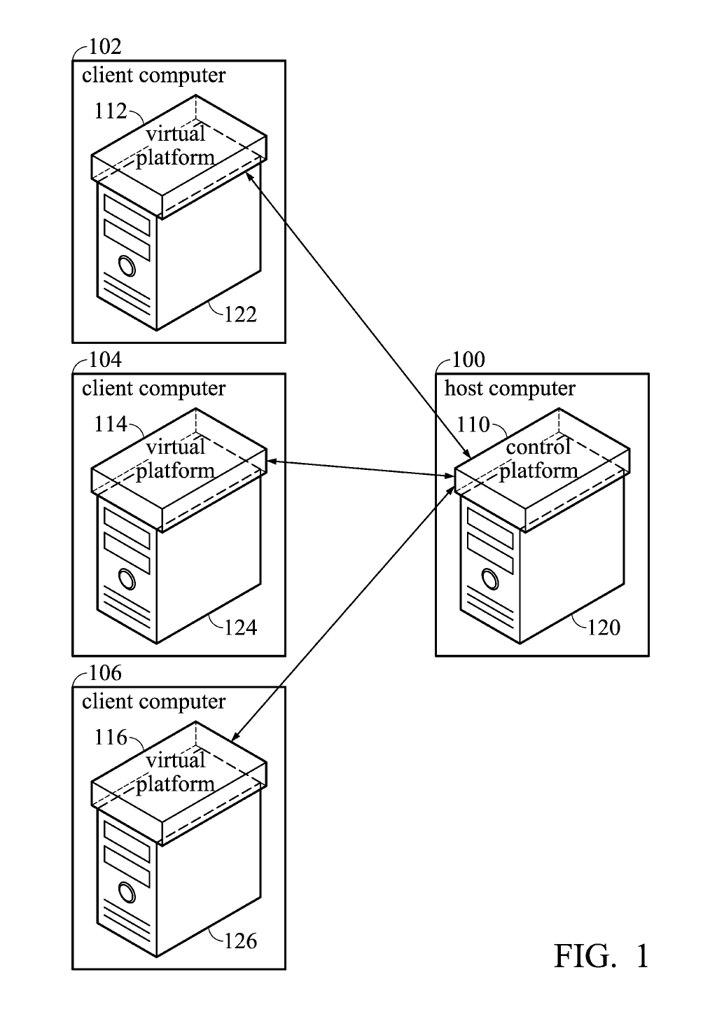

FIG. 1 illustrates a block diagram of a host computer and client computers in accordance with an embodiment of the invention. In this embodiment, a host computer 100 includes a computer 120 and a control platform 110 installed on the computer 120. Each client computer 102, 104, 106 includes a computer 122, 124, 126, and a virtual platform 112, 114, 116 installed on the computer 122, 124, 126, respectively. Control platform 110 and virtual platforms 112, 114, 116 can be programs that can realize functions. It is emphasized that the number of client computers in FIG. 1 is only exemplary and should not be limited thereto.

A host computer 100 is a computer that an administrator uses. The host computer 100 can be a server, a personal computer, or a notebook, etc. A control platform 110 of the host computer 100 provides functions to dispatch an IP addresses automatically and connect to a virtual machine. Conventionally, the control platform 110 dispatching IP addresses automatically to users in an internal network or internet service provider can adopt Dynamic Host Configuration Protocol (DHCP) and/or Trivial File Transfer Protocol (TFTP) providing downloading of virtual platform installation files.

Client computers 102, 104 and 106 are computers waiting for being installed operating systems therein. Taking the client computer 102 for example, the client computer 102 connects to the host computer 100 through a Pre-Boot execution environment (PXE) and network. When in PXE, the client computer 102 detects the host computer 100 through broadcast packets in the local area network (LAN)/internal network and asks the host computer 100 to dispatch an IP address. After obtaining the IP address from the host computer 100, the client computer 102 receives a virtual platform installation file transmitted by the control platform 110 and then installs a virtual platform 112 on the client computer 102. The client computer 102 joins the control platform 110 through the virtual platform 112, obtains a configuration file transmitted by the control platform 110, and establishes a control connection and a monitoring channel to the control platform 110. The control platform 110 installs an operating system on the client computer 102 via the control connection and obtains displays of the installation procedure of the client computer 102 via the monitoring channel. Other client computers such as client computer 104 and 106 can be installed in a way similar to the client computer 102.

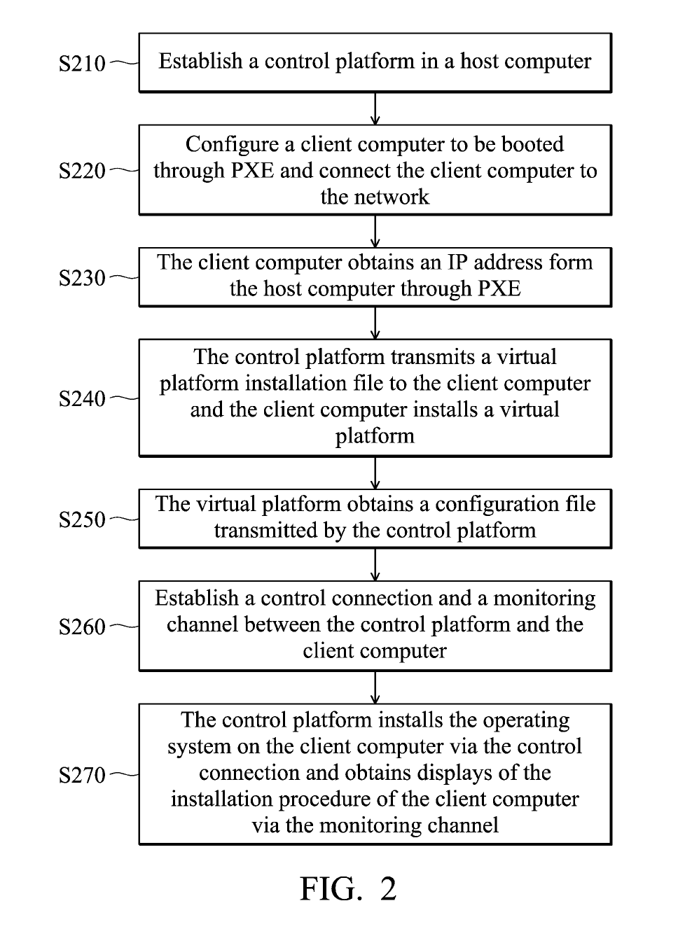

FIG. 2 illustrates a flow chart of a method for remote OS installation capable of monitoring an installation procedure in accordance with an embodiment of the invention.

In step S210, a control platform in a host computer is first established. In step S220, a client computer waiting for installation (such as client computer 102 in FIG. 1) is configured to be booted through the PXE in advance and connected to the network. For example, if the host computer and the client computer are in the same LAN, the control platform of the host computer is a DHCP server of the LAN. If the host computer and the client computer are not in the same LAN, a DHCP sever of a LAN including the client computer dispatches an IP address of a TFTP server of the LAN including the client computer to the host computer.

In step S230, the client computer obtains an IP address from the host computer through the PXE. In one embodiment, when in the PXE, the client computer detects the host computer through broadcast packets in the LAN/internal network and asks the host computer to dispatch an IP address.

In step S240, the control platform transmits a virtual platform installation file to the client computer and the client computer installs a virtual platform. The virtual platform installation file can be stored under a TFTP server directory so as to enable the client computer to download the virtual platform and then to install the virtual platform. After the client computer installs the virtual platform, the host computer obtains administration authority of the client computer through the virtual platform. In another embodiment, the virtual platform installation file is transmitted to client computer memory and executed to install the virtual platform. After accomplishing the installation, when the client computer is rebooted by the installed operating system, the virtual platform installation file in the client computer memory is deleted and would not be executed again to install the virtual platform.

In step S250, the virtual platform obtains a configuration file transmitted by the control platform. The configuration file includes settings of the network, settings of the network shared storage, and installation records of the operating system of the client computer. In some embodiments, the client computer carries out OS installation for the first time by the host computer. Therefore, the installation records of the operating system of the client computer don't exist or noted as not having an OS installed yet. In other embodiments, the client computer was previously installed with an OS by the host computer. Therefore, the installation records of the operating system of the client computer would note the number of times of OS installation, exact time of each installation, type of OS, OS edition, and installation set-up, etc.

In step S260, a control connection and a monitoring channel are established between the control platform and the client computer. The control connection is a network connection through which the host computer delivers commands to and controls the virtual platform of the client computer. The monitoring channel, for example, can be a virtual network computing (VNC) channel or a channel following the remote desktop protocol (RDP).

In step S270, the control platform installs the operating system on the client computer via the control connection and obtains displays of the installation procedure of the client computer via the monitoring channel. The control platform can be set to control a plurality of client computers at the same time. Therefore, the administrator can install the plurality of client computers and monitor displays of the installation. When there is a problem during the installation procedure, the administrator can obtain displays of the installation procedure and information thereof, so as to deal with the problem in a timely manner. After installing the OS, client computers can be rebooted by the installed operating system and don't have to be rebooted through the PXE.

In some embodiments, the virtual platform can be considered as a tiny operating system, including required driver modules. For example, the virtual platform can be constructed according to virtual technologies such as a Kernel-based Virtual Machine. The virtual platform includes network management functions, hard disk management functions and virtual machine management functions. Furthermore, the virtual platform supports installation of a Windows system and/or Linux system.

In one embodiment, the control platform further includes dispatching an ID to the client computer. After the client computer installs the operating systems, the control platform takes a record of the ID and notes installation information under the ID. For example, installation information comprises information of whether the client computer has been installed, and/or what operating system and relative settings of the installed client computer. That is, the control platform takes down installation records of the operating system. Therefore, if the client computer is booted through the PXE again, the control platform can determine whether the client has been installed and decide which one of tasks the client computer is going to do, the tasks including re-installing the operating system, recovering the operating system and its settings, and other work.

The method for remote OS installation described above can further install other application software and execute related settings to accomplish all settings which the client computer needs. The method can also be performed together with known remote installation software (such as Ghost) or remote desktop software (such as Windows remote desktop, Virtual Network Computing).

As described above, the method for remote OS installation according to an embodiment of the invention can support cross-platform OS installation (Linux and Windows) and can monitor displays of the installation procedure without additional hardware equipment such as a KVM switch or software.

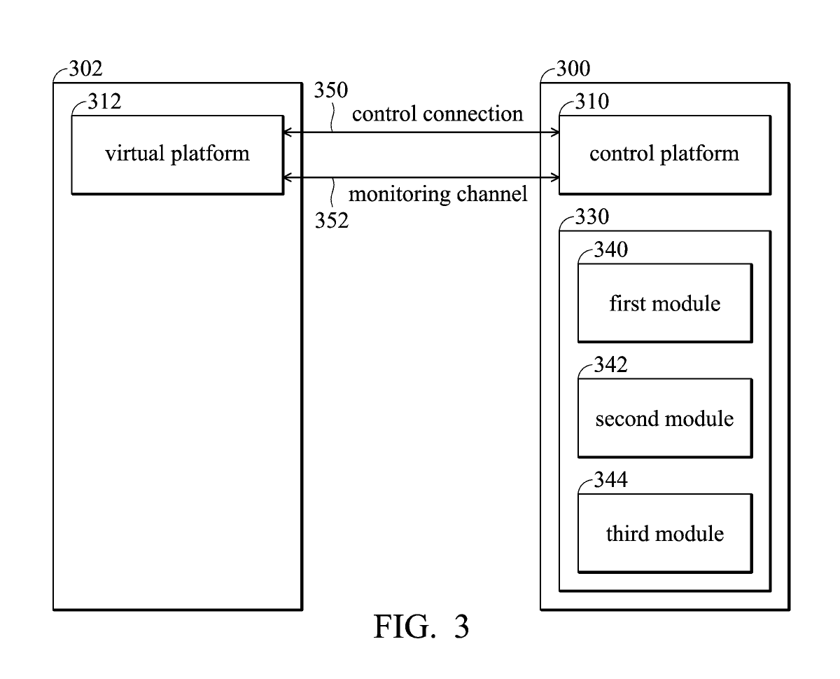

As shown in FIG. 3, an embodiment of the invention provides a system 330 for remote OS installation capable of monitoring an installation procedure. The system 330 is constructed in a host computer 300 to install an OS remotely on at least one client computer 302. The host computer 300 includes a control platform 310, and the client computer 302 connects to the control platform 310 of the host computer 300 through the PXE and obtains an IP address. The system comprises: a first module 340, enabling the control platform 310 to transmit a virtual platform installation file to the client computer 302 and installing a virtual platform 312 on the client computer 302; a second module 342, obtaining administration authority of the client computer 302 through the virtual platform 312 and establishing a control connection 350 and a monitoring channel 352 between the control platform 310 and the virtual platform 312; and a third module 344, installing an operating system on the client computer 302 via the control connection 350 and obtaining displays of the installation procedure of the client computer 302 via the monitoring channel 352. Since the related functions and description of the host computer 300, the client computer 302, the control platform 310 and the virtual platform 312 are described above, they will not be repeated here.

The method for remote OS installation capable of monitoring an installation procedure according to the invention can be implemented in a computer program product as a format of a code. The code can be included in solid media such as a floppy disk, an optical disk, a hard disk, storage media or any other electronic apparatus. The code of the computer program product is loaded by a machine, a computer or an electronic apparatus to implement the method for remote OS installation capable of monitoring an installation procedure. The method is applied to a computer network system, wherein the computer network system includes a host computer and at least one client computer. The host computer includes a control platform and the client computer includes a virtual platform. The client computer is configured to be booted through PXE and connected to the host computer through the network. Steps of the method are described above, so no repeated description will be given here.

In one embodiment, the computer program product comprises: a first code, enabling the control platform to transmit a virtual platform installation file to the client computer and installing a virtual platform on the client computer; a second code, obtaining administration authority of the client computer through the virtual platform and establishing a control connection and a monitoring channel between the control platform and the virtual platform; and a third code, installing an operating system on the client computer via the control connection and obtaining displays of the installation procedure of the client computer via the monitoring channel.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for remote OS installation capable of monitoring an installation procedure, applied to a host computer installing an OS remotely on at least one client computer, wherein the host computer includes a control platform, and the method comprises:
enabling the client computer to connect to the control platform of the host computer through a Pre-Boot execution environment (PXE) to obtain an IP address;
enabling the control platform to transmit a virtual platform installation file to the client computer and installing a virtual platform on the client computer;
enabling the host computer to obtain administration authority of the client computer through the virtual platform and establishing a control connection and a monitoring channel between the control platform and the virtual platform; and
enabling the host computer to install the OS on the client computer via the control connection and obtaining displays of the installation procedure of the client computer via the monitoring channel.

2. The method as claimed in claim 1, wherein the virtual platform includes network management functions, hard disk management functions and virtual machine management functions.

3. The method as claimed in claim 1, wherein when the client computer connects to the control platform of the host computer through the PXE, the client computer detects the host computer through broadcast packets and asks the host computer to dispatch the IP address.

4. The method as claimed in claim 1, wherein the virtual platform installation file is transmitted to client computer memory and then is executed to install the virtual platform.

5. The method as claimed in claim 1, wherein the control platform further includes a configuration file comprising settings of the network of the client computer, settings of the network shared storage, and installation records of the OS.

6. The method as claimed in claim 1, further comprising:
rebooting the client computer by the OS after accomplishing installation of the OS.

7. The method as claimed in claim 6, wherein if the client computer is booted through the PXE again, the control platform of the host computer determines which one of tasks the client computer is going to do, the tasks including re-installing the OS, recovering the OS and its settings, and other work.

8. A system for remote OS installation capable of monitoring an installation procedure, constructed in a host computer to install an OS remotely on at least one client computer, wherein the host computer includes a control platform, the client computer connects to the control platform of the host computer through a PXE to obtain an IP address, and the system comprises:
a first module, enabling the control platform to transmit a virtual platform installation file to the client computer and installing a virtual platform on the client computer;
a second module, obtaining administration authority of the client computer through the virtual platform and establishing a control connection and a monitoring channel between the control platform and the virtual platform; and
a third module, installing the OS on the client computer via the control connection and obtaining displays of the installation procedure of the client computer via the monitoring channel.

9. The system as claimed in claim 8, wherein the virtual platform includes network management functions, hard disk management functions and virtual machine management functions.

10. The system as claimed in claim 8, wherein the client computer obtains the IP address through the PXE when the client computer detects the host computer through broadcast packets and asks the host computer to dispatch the IP address.

11. The system as claimed in claim 8, wherein the virtual platform installation file is transmitted to client computer memory and then is executed to install the virtual platform.

12. The system as claimed in claim 8, wherein the control platform further includes a configuration file comprising settings of the network of the client computer, settings of the network shared storage, and installation records of the OS.

13. The system as claimed in claim 8, wherein the third module further includes rebooting the client computer by the OS after accomplishing installation of the OS.

14. The system as claimed in claim 13, wherein if the client computer is booted through the PXE again, the control platform of the host computer determines which one of tasks the client computer is going to do, the tasks including re-installing the OS, recovering the OS and its settings, and other work.

15. A computer program product for remote OS installation capable of monitoring an installation procedure, loaded by an electronic apparatus to execute a method for remote OS installation capable of monitoring an installation procedure, wherein the method is applied to a host computer installing an OS remotely on at least one client computer, the host computer includes a control platform, the client computer connects to the control platform of the host computer through a PXE to obtain an IP address, and the computer program product comprises:
a first code, enabling the control platform to transmit a virtual platform installation file to the client computer and installing a virtual platform on the client computer;
a second code, obtaining administration authority of the client computer through the virtual platform and establishing a control connection and a monitoring channel between the control platform and the virtual platform; and
a third code, installing an OS on the client computer via the control connection and obtaining displays of the installation procedure of the client computer via the monitoring channel.
